(19) United States
(12) Patent Application Publication
(10) Pub. No.: US 2025/0025980 A1
(43) Pub. Date: Jan. 23, 2025

(54) BACKUP PADS, SYSTEMS AND METHODS OF USE THEREOF

(71) Applicant: 3M INNOVATIVE PROPERTIES COMPANY, St. Paul, MN (US)

(72) Inventors: Aaron K. Neinaber, Lake Elmo, MN (US); Mark w. Orlando, Chesterfield Township, MI (US); Brett R. Hemes, Woodbury, MN (US); Xin Dong, Woodbury, MN (US); Jonathan B. Arthur, Hudson, WI (US); Nathan J. Herbst, Woodbury, MN (US); Rufus C. Sanders, Burnsville, MN (US)

(21) Appl. No.: 18/714,659

(22) PCT Filed: Nov. 30, 2022
(86) PCT No.: PCT/IB2022/061609

§ 371 Date: May 30, 2024

Related U.S. Application Data
(60) Provisional application No. 63/264,988, filed on Dec. 6, 2021.

(51) Int. Cl. B24B 27/00; B24B 19/26; B24B 55/02; B25J 11/00

(52) U.S. Cl. CPC B24B 27/00; B24B 19/26; B24B 55/02; B25J 11/0065

(57) ABSTRACT

A robotic abrading system that includes a robotic tool coupled to a robotic arm. The robotic arm is configured to move the robotic tool into an abrading position with respect to a workpiece. The system also includes a backup pad coupled to the robotic tool. The system also includes a polishing pad coupled to the backup tool. The backup pad or the polishing pad include a heat accumulation reduction mechanism that passively reduces heat accumulation within the backup pad during successive polishing operations.

### BACKGROUND

Clear coat repair is one of the last operations to be automated in the automotive original equipment manufacturing (OEM) sector. Techniques are desired for automating this process as well as other paint applications (e.g., primer sanding, clear coat defect removal, clear coat polishing, etc.) amenable to the use of abrasives and/or robotic inspection and repair.

Prior efforts to automate the detection and repair of paint defects include the system described in US Patent Publication No. 2003/0139836, which discloses the use of electronic imaging to detect and repair paint defects on a vehicle body. The system references the vehicle imaging data against vehicle CAD data to develop three-dimensional paint defect coordinates for each paint defect. The paint defect data and paint defect coordinates are used to develop a repair strategy for automated repair using a plurality of automated robots that perform a variety of tasks including sanding and polishing the paint defect.

### SUMMARY

A. robotic abrading system that includes a robotic tool coupled to a robotic arm. The robotic arm is configured to move the robotic tool into an abrading position with respect to a workpiece. The system also includes a backup pad coupled to the robotic tool. The system also includes a polishing pad coupled to the backup tool. The backup pad or the polishing pad include a heat accumulation reduction mechanism that passively reduces heat accumulation within the backup pad during successive polishing operations.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a schematic of a robotic paint repair system in which embodiments of the present invention are useful.

FIG. 2 is a schematic of a paint repair robot which may be useful in embodiments of the present invention.

FIG. 3 illustrates frictional polishing pads after manual and robotic-driven operations.

FIGS. 4A-4E illustrate a frictional polishing pad system for a robotic abrasive system in accordance with embodiments herein.

FIGS. 5A-5E illustrate a robotic abrasive tool with improved heat dissipation in accordance with embodiments herein.

FIG. 6A-6D illustrates frictional polishing pads for a robotic abrasive system in accordance with embodiments herein.

FIG. 7 illustrates a robotic abrading system in accordance with embodiments described herein.

FIG. 8 illustrates a method of polishing a surface in an embodiment of the present invention.

FIGS. 9-10 illustrate backup pad systems described in greater detail in the embodiments.

### DETAILED DESCRIPTION

Recent advancements in imaging technology and computational systems has made the process of clear coat inspection at production speeds possible. In particular, stereo deflectometry has recently been shown to be capable of providing images and locations of paint and clear coat defects at appropriate resolution with spatial information (providing coordinate location information and defect classification) to allow subsequent automated spot repair. However, as robotic systems have started to replace human repair technicians, new problems have arisen.

As used herein, the term “vehicle” is intended to cover a broad range of mobile structures that receive at least one coat of paint or clear coat during manufacturing. While many examples herein concern automobiles, it is expressly contemplated that methods and systems described herein are also applicable to trucks, trains, boats (with or without motors), airplanes, helicopters, etc.

The term “paint” is used herein to refer broadly to any of the various layers of e-coat, filler, primer, paint, clear coat, etc. of the vehicle that have been applied in the finishing process. Additionally, the term “paint repair” involves locating and repairing any visual artifacts (defects) on or within any of the paint layers. In some embodiments, systems and methods described herein use clear coat as the target paint repair layer. However, the systems and methods presented apply to any particular paint layer (e-coat, filler, primer, paint, clear coat, etc.) with little to no modification.

As used herein, the term “defect” refers to an area on a worksurface that interrupts the visual aesthetic. For example, many vehicles appear shiny or metallic after painting is completed. A “defect” can include debris trapped within one or more of the various paint layers on the work surface. Defects can also include smudges in the paint, excess paint including smears or dripping, as well as dents.

Paint repair is one of the last remaining steps in the vehicle manufacturing process that is still predominantly manual. Historically this is due to two main factors, lack of sufficient automated inspection and the difficulty of automating the repair process itself. Paint and clear coat repair standards surround aesthetics judged by the human eye—the dealership accepting the vehicle and the eventual customer who will inspect the vehicle prior to purchase.

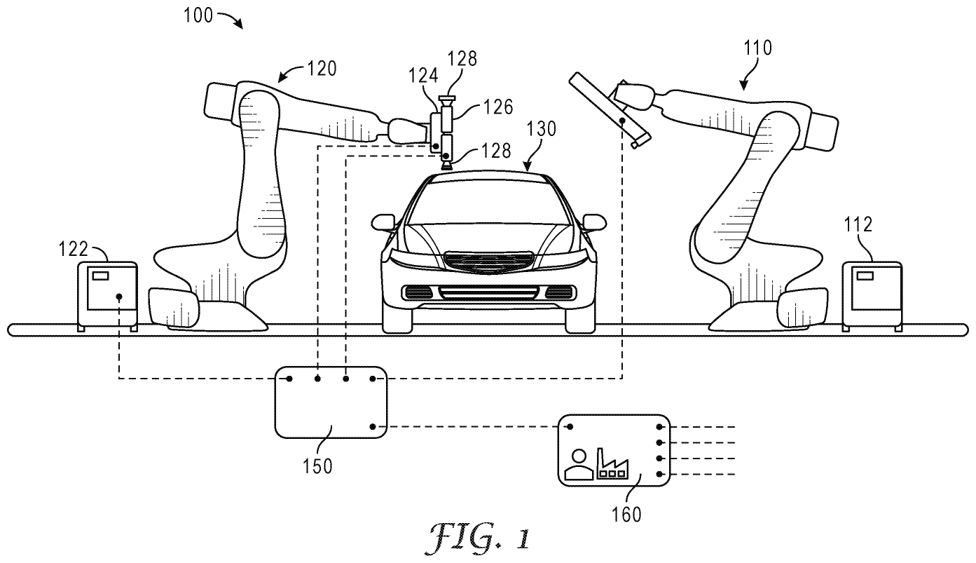

FIG. 1 is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two tools 128, which may be the same tool, or different tools, as further described in co-pending International Publications WO 2021/105867 and WO 2021/105876, both published Jun. 3, 2021. However, other arrangements are also expressly contemplated.

FIG. 1 is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two processing tools 128. However, other arrangements are also expressly contemplated.

The current state of the art in vehicle paint repair is to use fine abrasive and/or polish systems to manually sand/polish out the defects, with or without the aid of a power tool, while maintaining the desirable finish (e.g., matching specularity in the clear coat). An expert human executing such a repair leverages many hours of training while simultaneously utilizing their senses to monitor the progress of the repair and make changes accordingly. Such sophisticated behavior is hard to capture in a robotic solution with limited sensing.

Additionally, abrasive material removal is a pressure driven process while many industrial manipulators, in general, operate natively in the position tracking/control regime and are optimized with positional precision in mind. The result is extremely precise systems with extremely stiff error response curves (i.e., small positional displacements result in very large corrective forces) that are inherently bad at effort control (i.e., joint torque and/or Cartesian force)). Closed-loop force control approaches have been used (with limited utility) to address the latter along with more recent (and more successful) force controlled flanges that provide a soft (i.e., not stiff) displacement curve much more amenable to sensitive force/pressure-driven processing. The problem of robust process strategy/control, however, remains and is the focus of this work.

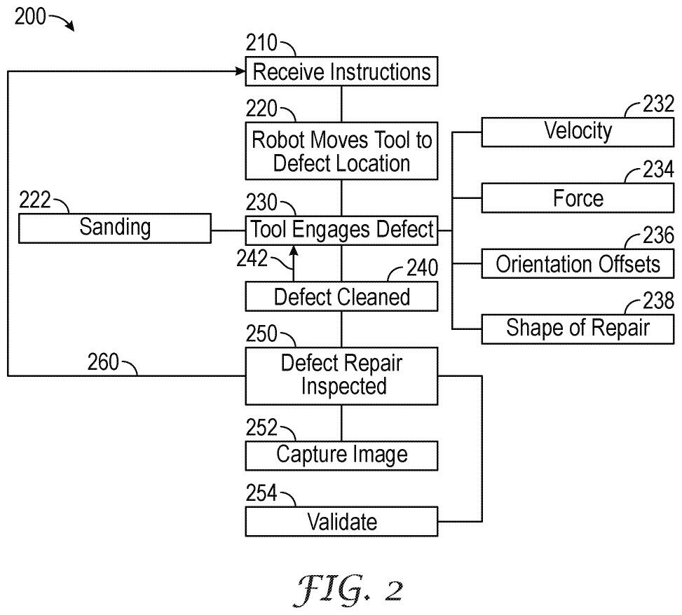

FIG. 2 illustrates a method of robotic defect repair in which embodiments of the present invention may be useful. Method 200 is an overview of how a robotic repair system repairs a defect in accordance with at least some embodiments described herein.

In block 210, instructions are received from a robot controller, such as application controller 150 in FIG. 1, for example. Different components of robotic repair including controller, robot, force control unit, tool (mounts, motor, end effector), movement patterns, etc. all receive instructions from the robot controller.

In block 220, a robotic motion controller moves an abrasive article, mounted to a tool, in place to prepare to engage a defect. Defect locations may be known from an inspection system or otherwise identified, for example based on a CAD file of the worksurface.

In block 230, the abrasive article engages the defect. Engaging the defect may include sanding the defect area, as indicated in block 222, or polishing the defect area, as indicated in block 224.

In block 240, the defect area is cleaned. Cleaning may include wiping away any fluids used in sanding or polishing, as well as wiping away debris. As indicated in block 342, after a cleaning step, the tool may re-engage the defect.

In block 250, the defect area is inspected, to determine whether the repair is sufficient. If additional repair is needed, method 200 may include the robotic repair unit receiving new instructions, as indicated by arrow 260, and the method may repeat. Inspecting a defect repair may include capturing post-repair images 252, which may be presented to a repair operator or saved as needed. Inspecting may also include validating the repair, as indicated in block 254, which may include comparing pre- and post-repair images, detecting whether a defect will be visible/noticeable to the human eye, or another suitable validation technique.

Automating the defect repair process introduces new problems that were not experienced by human operators. One example, in the polish context (step 224 of method 200), is created by the speed at which the robotic repair unit can polish defects. A human operator may go through 3 different polishing pads per day, for example. However, it was seen that when the repair process was automated and one polishing pad was used to polish defects sequentially, the foam experienced degradation rapidly, after only 5-10 defect repair operations.

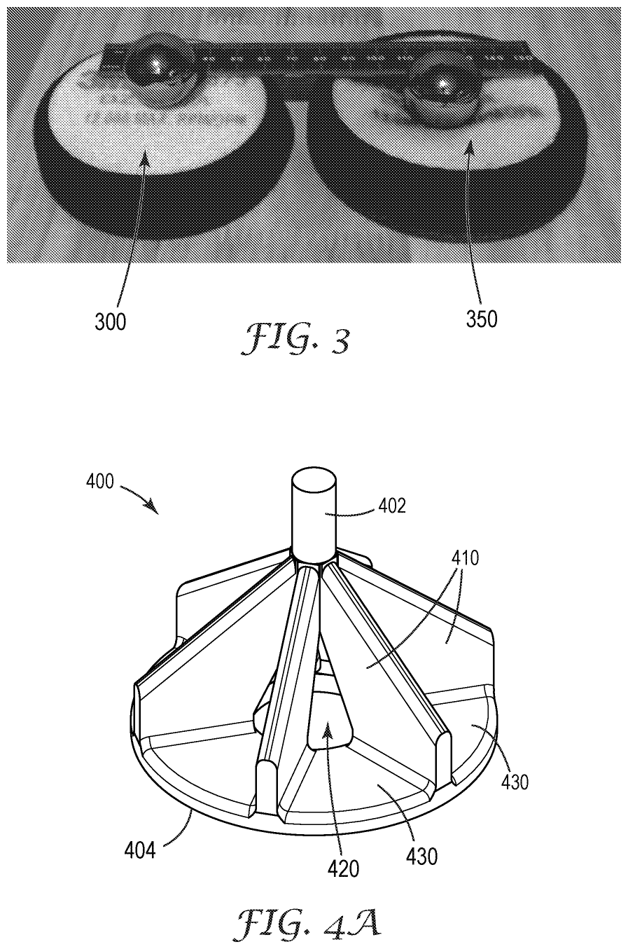

FIG. 3 illustrates frictional polishing pads after manual and robotic-driven operations. 3 illustrates a polishing pad 300 after use by a human operator, and a polishing pad 350 after use by a robotic repair unit. A ball bearing has been placed on top of each to more clearly show the depression in polishing pad 350. Polishing pads 300, 350 include a lofty foam impregnated with polishing material. A human operator pauses between polishing operations, which in contrast with an automated system that continues with minimal interruption from one repair to another In the automated setting, polishing can happen with a much faster cycle time, which causes heat to build up within the pad, even at the same force applied by a human operator. The rapid automated use of the pad overheated the polishing pad with the heat continuing to build up to the point of melting the center of the pad during normal polishing conditions with standard polish on a painted panel surface. When such deformation is present, pad 350 must be replaced. The heat builds up at the interface of the pad and the backup pad, in the center of the pad.

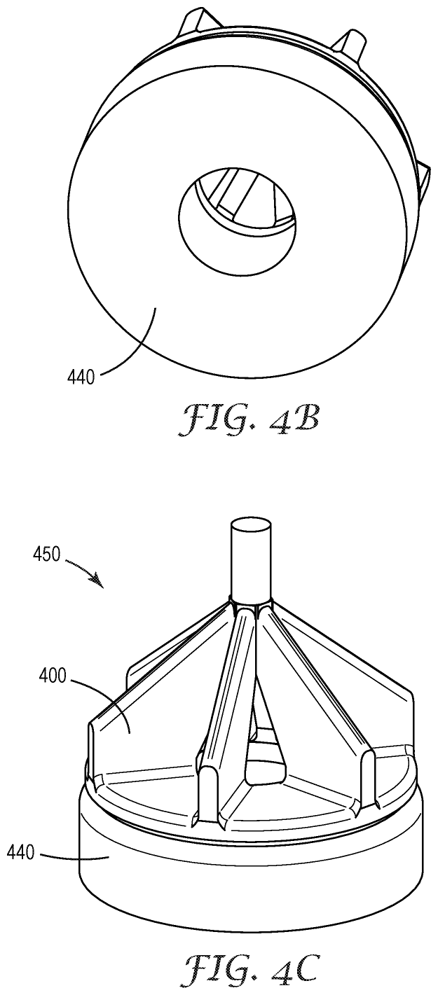

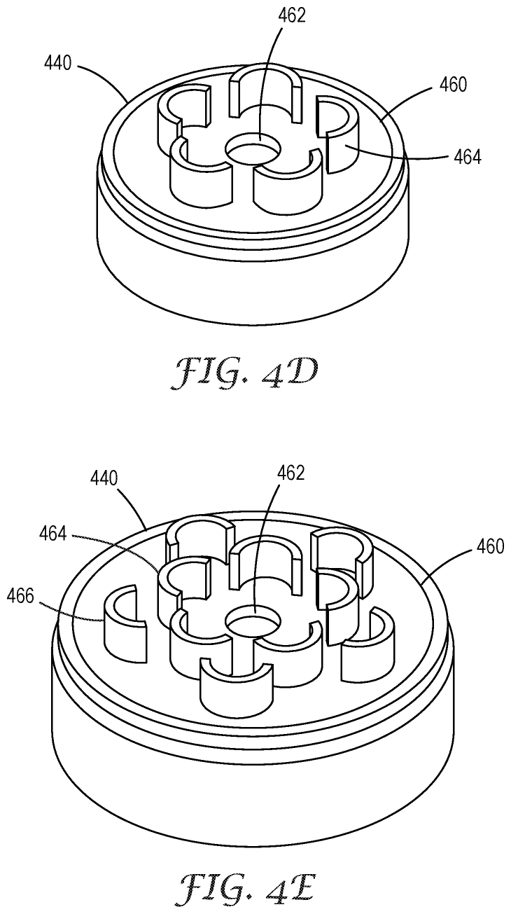

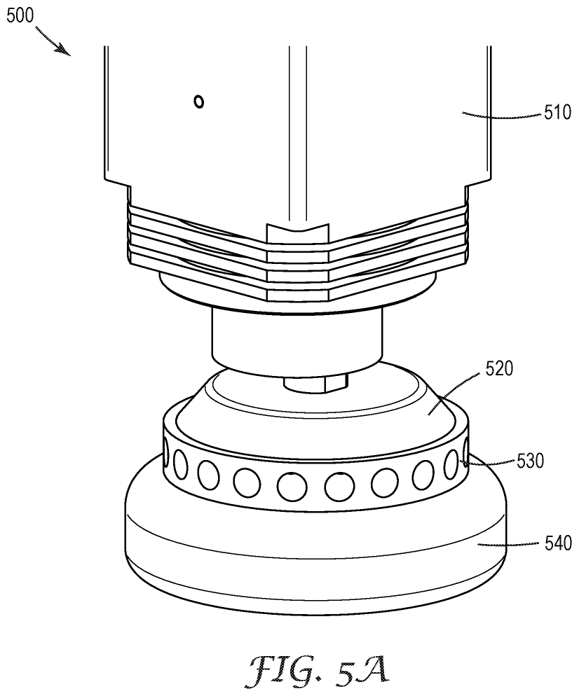

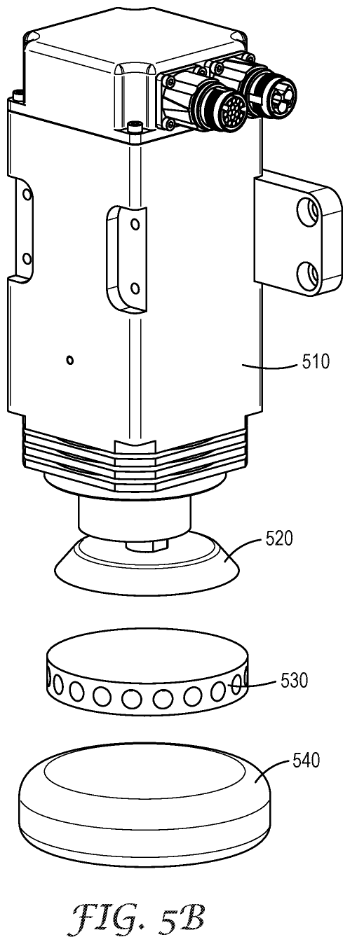

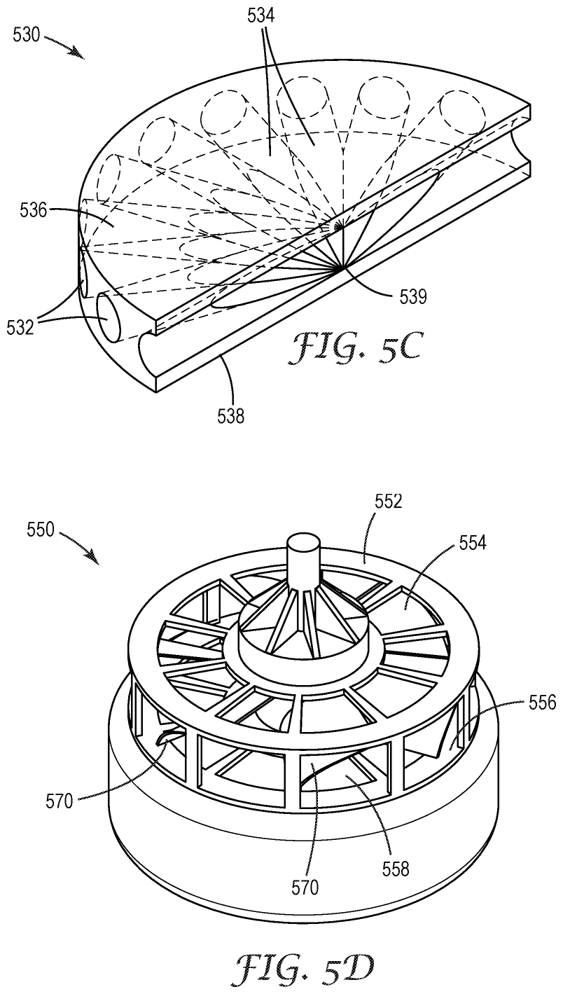

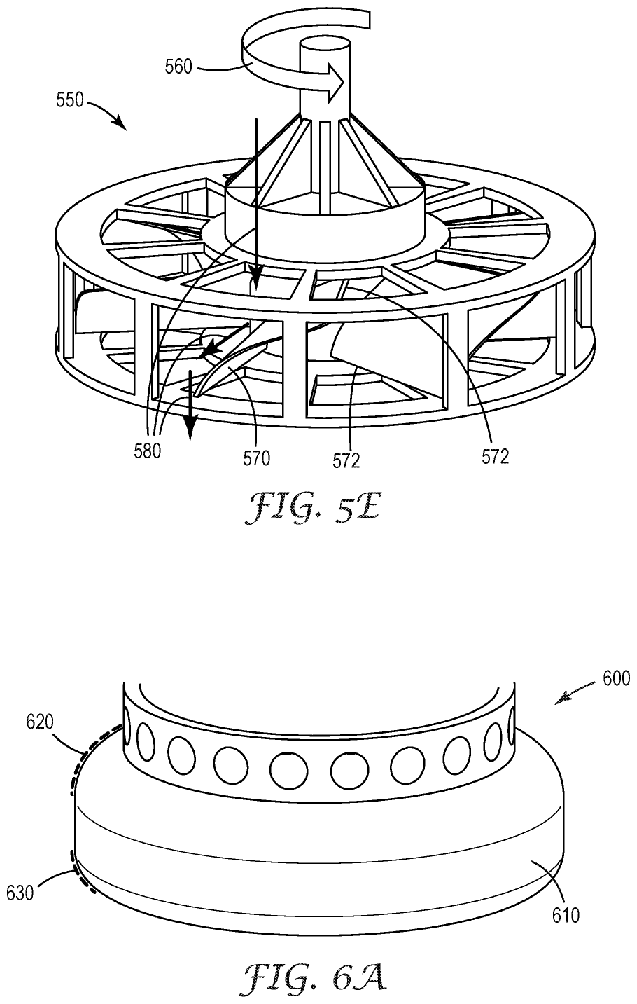

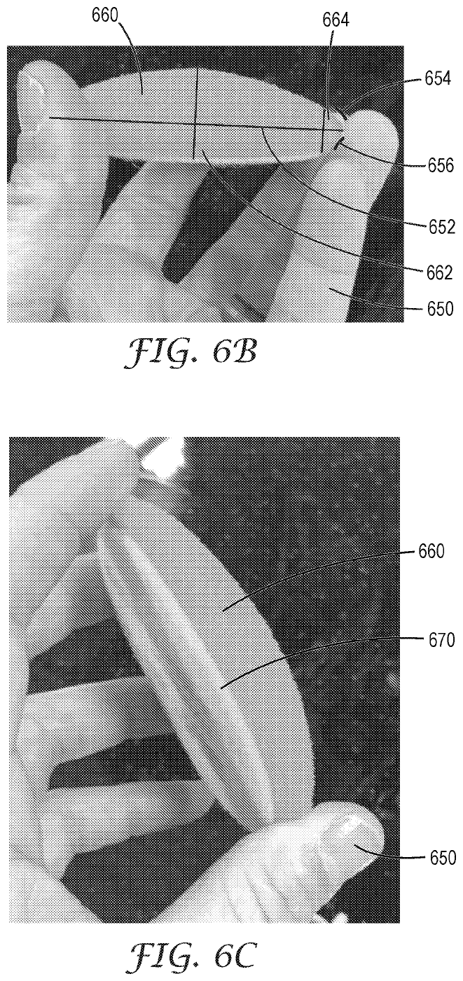

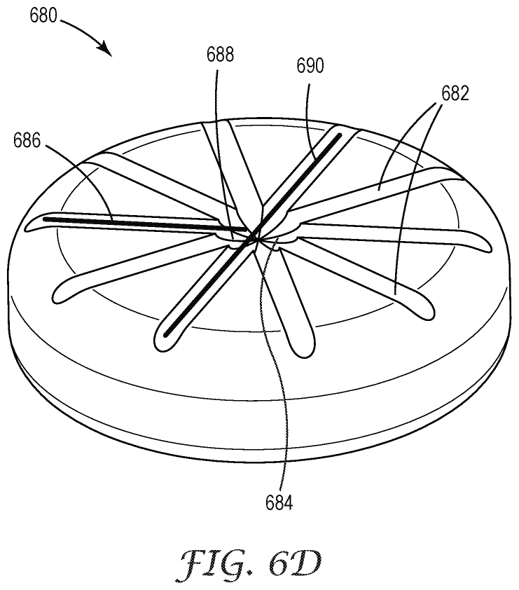

A polishing system is desired that can facilitate the rapid polishing that a robotic repair unit with similar or better polishing pad useful life is desired. Disclosed herein are systems and methods for dissipating heat generated during an automated polishing repair. FIGS. 4 and 5 illustrate interface systems that facilitate moving air around a polishing pad when in use. FIGS. 6A-6C illustrate polishing pad designs that better dissipate heat than traditional polishing pads. These embodiments may be used in combination, or separately, as described herein.

FIGS. 4A-4E illustrate a frictional polishing system for a robotic abrasive system in accordance with embodiments herein. Instead of a traditional backup pad, an interface 400, shown in FIG. 4A, couples to a tool using a spindle attachment 402, and a polishing pad on attachment surface 404.

Interface 400 includes a plurality of airflow components 410, illustrated in FIG. 4A as fins. While a six-fin configuration is illustrated in FIG. 4A, it is expressly contemplated that more, or fewer fins may be present. A robotic repair system, such as system 100, includes a servo-powered tool that rotates an abrasive article against a worksurface, such as a polishing pad against a vehicle surface, which Interface 400, when coupled to a tool at attachment 402, is similarly configured to rotate. As interface 400 rotates, air is forced to flow in and around fins 410. A center hole 420 exposes a polishing pad surface where heat previously accumulated. However, while a single larger center hole 420 is illustrated, it is expressly contemplated that multiple small holes, slots or other aperture arrangements may be used to provide airflow through interface 400 to a polishing pad.

Depending on operational settings, such as rotational speed or force, it may be necessary to provide higher, or lower, airflow levels. For example, it is not desired to provide so much airflow that liquid polish dries out. Fins 410 may therefore, in some embodiments designed for operations needing higher airflow, have additional airflow inducing features such as curvature, holes or cavities. While FIG. 4A illustrates an embodiment having seven fins 410, it is contemplated that more or fewer may be used. Additionally, other airflow inducing shapes, such as the turbine illustrated in the Examples, are also expressly contemplated.

A planar structure 430 provides an attachment surface for coupling to a polishing pad or other abrasive article. However, while structure 430 is illustrated as flat on both abrasive attachment side 404 and a fin attachment side, opposing abrasive attachment side, it is expressly contemplated that features or curvature may be present. For example, grooves or other uneven surface features on attachment side 404 may increase airflow to a polishing pad. Such features may be present instead of, or in addition to, center hole 420.

In some embodiments, as illustrated in FIG. 4B, interface 400 is paired with a polishing pad 440 that has a center hole. However, it is expressly contemplated that a traditional polishing pad, without a center hole, may also be used with interface 400, as illustrated in polishing system 450 of FIG. 4C. In fact, it may be preferred to use a traditional polishing pad, as a robotic system would otherwise have to be programmed to sufficiently polish a worksurface without the non-polishing area of the center hole.

Interface 400 allows for passive cooling of a polishing pad by using rotation of a robotic tool to drive airflow to exposed surface area of the polishing pad where heat accumulates. No additional air lines or heat exchanging devices are required. It was found that, at standard operational settings, sufficient airflow was present to prevent overheating.

Another interface design is illustrated in FIGS. 4D and 4E. FIGS. 4D and 4E illustrate a polishing pad 440 coupled to an interface 460. Interface 460 includes an aperture 462, which receives a too driveshaft. In some embodiments, a coverplate (not shown in FIGS. 4D or 4E) is placed between interface 460 and a tool. As the tool spins, air is forced to flow around curved portions 464, 466, dissipating heat by removing air warmed by heat trapped in polishing pad 440. FIGS. 4D and 4E illustrate embodiments where a plurality of curved portions 464, and optionally a second plurality of curved portions 466 are symmetrically arranged about center hole 462. However, other arrangements are expressly contemplated. Additionally, FIGS. 4D and 4E illustrate embodiments where five curved portions 464 are equidistantly spaced about aperture 462. However, in other embodiments there are only three, or four, or there are more than five, such as six, seven, eight, nine, ten or more curved portions. FIGS. 4D and 4E also illustrate embodiments where curved portions 464, 466 are semi-circular in shape. However, it is expressly contemplated that other shapes may also be suitable such as arcs, semi-ellipses, straight portions, angled portions, or other portions.

FIGS. 5A-5E illustrate robotic abrasive tools with improved heat dissipation in accordance with embodiments herein. One benefit of robotic systems over humans is that robots can be more precise which allows for the minimization of the repaired area. While traditional polishing pads are closer to 3 inches in diameter, the illustrated polish pad in FIGS. 5A-5B can be smaller. Testing was done with a polishing pad having a diameter of 2.25 inches.

FIG. 5A illustrates an abrading system 500 designed to be used on a robotic arm. Robotic tool 510 couples to a backup pad 520 which is coupled to a polishing pad 540. Similar to the embodiment illustrated in FIGS. 4A-4C, an interface 530 is present between a backup pad 520 and a polishing pad 540 of system 500. While FIGS. 5A-5C illustrate an interface 530 as a separate component from backup pad 520, it is expressly contemplated that, in some embodiments, they are one integrated unit. Interface 530 serves to provide a source of airflow at or near the internal surface of the polishing pad

Interface 530 illustrates one potential embodiment of an airflow facilitation system. Interface 530 provides a gap between backup pad 520 and polishing pad 540 so that air can flow over polishing pad 540, preventing overheating. Interface 530 may take any suitable shape, however sufficient adhesion is required to both backup pad 520 and polishing pad 540 so that, during operation, polishing pad 540 does not become detached from system 500. For example, in one embodiment, backup pad 520 has a series of grooves on the surface that interacts with polishing pad 540 that serve as interface 530.

FIG. 5B illustrates an exploded view of assembly 500. FIG. 5C illustrates an isolated cutaway view of interface 530. In the illustrated embodiment, interface 530 is a cylinder with channels 534 extending from apertures 532. However, other shapes of interface 530 and channels 534 are also possible. In the illustrated embodiment, channels 534 converge in the center 539 of interface 530, forming a chamber for airflow to flow over the surface pf polishing pad 540 where heat builds up, namely in the center of polishing pad 540 on the side of polishing pad 540 that connects to backup pad 520. In the embodiment illustrated in FIG. 5C, top surface 536 and bottom surface 538 are both flat and free of cavities or apertures. However, it is expressly contemplated that, for example, one or more apertures are present on a bottom surface 538 that couples to polishing pad 540 to increase airflow to the area where heat accumulates.

FIGS. 5D and 5E illustrate another embodiment of an interface 550. An interface 550 has a tool-connecting side 552 and an abrasive article connecting side 556. Sides 552, 556, in some embodiments, are flat surfaces. Either side 552 or side 556, or both as illustrated in FIG. 5D, may include apertures 554, 556 to increase airflow and heat dissipation during operation. An airflow member 570, in some embodiments, extends from surface 552 to surface 558. Airflow member 570 couples to surface 552 at an angle other than a right angle. In some embodiments, airflow member 570 has rotational symmetry, but is asymmetric with respect to an axis parallel to sides 552, 556.

Operation of interface 550 is illustrated in FIG. 5E. As illustrated in FIG. 5E, when interface 550 is coupled to a polishing pad and is rotated, illustrated by arrow 560, air is forced along path 580, through interface 550, along the curvature of airfoil 570, and down toward a surface of a polishing pad. FIGS. 5D-5E illustrate embodiments where a cylindrical surface connecting sides 552, 556 has large apertures that constitute a majority of that surface. In such embodiments, at least some air may be directed through one or more apertures in the cylindrical surface. As air passes over the polishing pad surface, and exits the cylindrical surface, it absorbs some heat from the polishing pad, reducing or eliminating heat build up in the polishing pad.

However, it is expressly contemplated that, in some embodiments, apertures in a cylindrical surface are smaller than those illustrated in FIGS. 5D-5E, for example constituting only about 50% of the cylindrical surface area, only about 40% of the cylindrical surface, only about 30% of the cylindrical surface, only about 20% of the cylindrical surface, only about 10% of the cylindrical surface or even less. In some embodiments, the cylindrical surface is free of apertures. In such embodiments, air is forced along path 580. Apertures may increase airflow through interface 550.

Airflow member 570, in some embodiments, has a width that is similar to a distance from a center shaft to an edge of interface 550, such that air entering interface 550 is forced along path 580.

FIG. 6A-6C illustrates frictional polishing pads for a robotic abrasive system in accordance with embodiments herein. FIGS. 6A-6C illustrate some examples of how a polishing pad can be designed to reduce heat accumulation. While traditional polishing pads are often designed to be symmetric to a center axis, as illustrated in FIG. 6A, a polishing pad 600 may be asymmetric with respect to axis 610. As illustrated, a radius of curvature 620 differs from a radius of curvature 630.

FIGS. 6B and 6C illustrate polishing pads constructed as described in greater detail in the Examples below. Polishing pads 650 were formed to reduce heat accumulation during a polishing operation. An axis 652 that runs parallel to a backup pad attachment side 670 extends through the polishing bad at the point of greatest diameter. In the center of the polishing pad, perpendicular to axis 652, is a thickest point 662 of pad material. At an edge of an attachment surface 670 is a thin point 664 of pad material 660. For example, in the constructed embodiments illustrated in FIGS. 6B-6C, material 660 is one inch thick at point 662 and one quarter inch thick at point 664, at the edge of attachment surface 670. However, while a variation in thickness across a polishing area of four times is illustrated, it is contemplated that other variations may be sufficient, for example only a variation of twice the thickness, or only the variation of three times the thickness.

FIG. 6D illustrates a polishing pad 680, with a plurality of channels 682 extending partially or completely therethrough. Channels 682 are illustrated as part of a surface of article 680, however it is expressly contemplated that they may instead, or in addition, extend through the interior of pad 680.

FIG. 6D illustrates a number of channels 682 that intersect at an aperture 684. However, it is expressly contemplated that some of channels 682 may not be coplanar, in some embodiments, and may not intersect. Additionally, while a channel may extend partially through polishing pad, as illustrated by channel 686, it may also extend completely through, as indicated by channel 690.

It is also expressly contemplated that the composition of the polishing pad may be altered in order to reduce heat accumulation. For example, instead of a continuous foam layer 660 from one surface of a polishing pad to another, in some embodiments herein a dual layer foam is used for robotics applications, with a lower density foam side being used on the attachment surface to an interface or a backup pad, and a high density layer being used for polishing purposes. The lower density foam layer may not be suitable for polishing purposes, but is present to provide airflow from the exterior of polishing pad 650 into the interior of the high density foam layer.

Similarly, a heat dissipating material may be integrated into a polishing pad, such as strands of aluminum, copper or another thermoconducting material running through the area where heat tends to accumulate, e.g. in the area between axis 662 and an interface or backup pad coupled to polishing pad 600. In embodiments where the heat sink material may induce scratches on a surface, it may be preferred to restrict the heat sink material to a volume of polishing pad 650 that will not contact a worksurface. The heat dissipating material may not be confined to a specific region, in some embodiments, but may extend through the volume of the polishing pad 650.

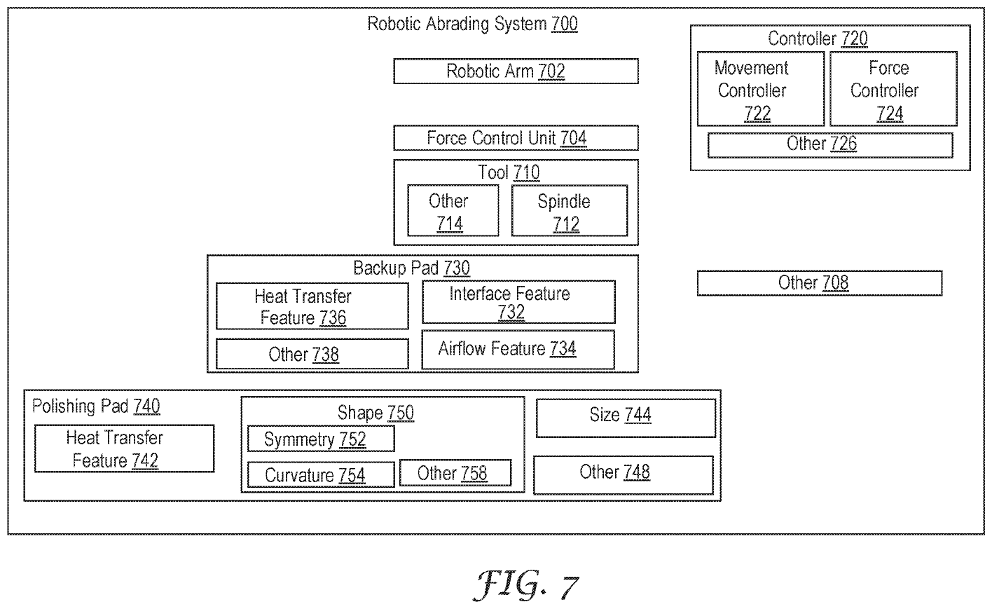

FIG. 7 illustrates a robotic abrading system in accordance with embodiments described herein. A robotic abrading system 700 may be stationary or mobile, or may have stationary or mobile components. As discussed above with respect to FIGS. 1-2, robotic abrading system may receive input from a vision system, or may otherwise receive instructions for traveling to an area on a worksurface to polish, for example from a movement controller component 722 of a system controller 720.

Robotic abrading system 700 includes a robotic arm 702 that moves a tool 710 within proximity of a worksurface to be polished. Coupled to robotic arm 702 is a force control unit 704, which may be controlled by a force controller 724.

Tool 710 includes a spindle 712, drive shaft or other connection mechanism. Tool 710 may also have other components 714. Tool 710 couples to a backup pad 730 which may also couple to a polishing pad 740.

In some embodiments, backup pad 730 includes an interface feature 732 that couples to polishing pad 740. Backup pad 730, using interface feature 732, distributes force provided from force control unit through spindle such that even force is applied across the surface area of polishing pad 740. Backup pad 730 may also, in some embodiments, include an airflow feature 734 that circulates air within the backup pad 730, over or through the interface feature 732. For example, in some embodiments, interface feature includes one or more apertures that allow airflow to directly contact polishing pad 740. In other embodiments, air flow feature 734 allows air to flow through interface feature 732, without direct contact to polishing pad 740. Airflow features 734 may include channels through interface feature 732, apertures within interface feature 732, fins extending from or through interface feature 732, or other air flow inducing structures, such as the turbine structure discussed in the Examples.

In some embodiments, a polishing pad 740 is modified for robotic abrading. However, it is expressly contemplated that backup pad 730 may be used with traditional backup pads. It is also contemplated that polishing pad 740 may be used with traditional backup pad. Polishing pad 740 has a shape 750 selected for a robotic abrading system 700. Polishing pad 740 may have symmetry 752 with respect to a central axis, extending down from a spindle 712, but may be asymmetrical with respect to an axis along the largest diameter of polishing pad 740. For example, a height differential may be present, for example with a center of the polishing pad 740 being at least twice as thick as a thickness at the edge of polishing pad 740 at backup pad 730, or at least three times as thick, or even at least four times as thick. Additionally, while traditional backup pads have the same radius of curvature where the polishing pad sides meet the worksurface as that where the polishing pad sides meet the backup pad interface feature 730, it is expressly contemplated that curvature 754 may vary in some embodiments. For example, a first radius of curvature may be present at the backup pad interface, and a second radius of curvature may be present at the worksurface interface. The radius of curvature at the worksurface interface may be larger than the radius of curvature at interface 730. Shape 750 may also include other modifications 758 as compared to traditional polishing pads.

Polishing pad 740 may also have a size 744 that, in one embodiment, is smaller than traditional backup pads, which allows for more maneuverability over curved areas of a workpiece—e.g. contours on a car hood or trunk, in and around rearview mirrors, etc. Polishing pad 740 may be 2.25 inches in diameter, or as small as 2 inches in diameter, or as small as 1.5 inches in diameter. Smaller polishing pads increase the time it takes to complete a polishing operation, which is why larger polishing pads are traditionally used in manual operations, but smaller polishing pads have reduced heat accumulation and provide more maneuverability for a robotic abrading system 700.

In some embodiments, polishing pad 740 includes a heat transfer feature 742. Heat transfer feature 742 may be part of the material construction of polishing pad 740, such as a multilayer pad construction. A lower density foam layer may couple to backup pad 730 while a higher density foam layer may contact a worksurface during a polishing operation. The lower density foam layer may not be suitably dense for a polishing operation, but lofty enough to provide airflow.

Alternatively or additionally, heat transfer feature 742 may include a heat dissipation component, such as aluminum or copper strands extending through a portion of polishing pad 740. For example, aluminum or copper strands may extend through volumes where heat accumulation traditionally occurs. In some embodiments, the heat dissipation component does not extend throughout a thickness of the polishing pad, such that it does not contact a worksurface.

Polishing pad 740 may include other features 748. For example, in some embodiments polishing pad 740 is impregnated with polishing material prior to use.

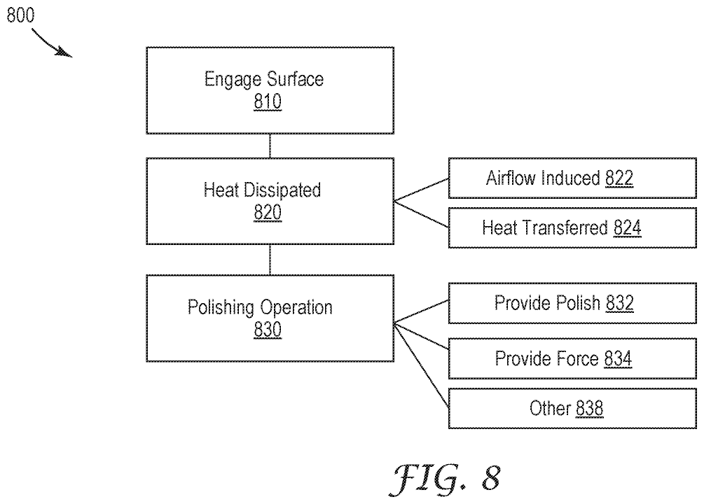

FIG. 8 illustrates a method of polishing a surface in an embodiment of the present invention. Method 800 may be used with any of the embodiments described herein, or other suitable embodiments.

In block 810, a polishing pad engages a worksurface. The polishing pad is directed to the worksurface using a robotic abrading system. The polishing pad may be specially designed for use in a robotic abrading system, for example with a smaller size and increased variation in width across the diameter.

In block 820, heat is dissipated from within the polishing pad. Without intervention, a traditional backup pad coupled to a robotic polishing unit experiences heat accumulation within the pad, on the side interfacing with a backup pad. It is suspected that heat accumulates there, instead of at the contact area with the worksurface, because the heat generated at the worksurface permeates through the pad. The exterior of the pad cools down in between polishing operations from exposure to ambient air. However, the heat cannot escape from the interior volume fast enough to keep up with the speed at which a robotic abrading unit can facilitate successive polishing operations. Heat can generally be dissipated in two ways—by inducing airflow, as indicated in block 822, or by transferring heat out of the accumulation zone, as indicated in block 824.

Airflow can be induced, in some embodiments, by modifying a backup pad coupled to the robotic tool on one side, and the polishing pad on the other side. Traditional backup pads couple to a polishing pad, for example using an adhesive, such that the substantially the entire area of the backup pad attachment side of the polishing pad is coupled to the backup pad. This causes heat to be trapped on the backup pad side of the polishing pad. Modifying the backup pad to allow airflow over or through the polishing pad can reduce heat. The backup pad may, for example, have one or more apertures on the polishing attachment side that allow ambient air to contact the polishing pad. The backup pad may also include airflow inducing features, such as channels, fins or other features designed to, with the rotation of the tool, cause air to flow through the backup pad.

Airflow can also be induced, in some embodiments, by modifying a polishing pad to induce airflow. For example, while most polishing pads are substantially flat on both sides, a polishing pad for a robotic abrasive system may be curved on a worksurface contacting side, which provides more flexibility to polish curved surface, and reduces an overall volume of the polishing pad, reducing the amount of heat that can accumulate. Similarly, airflow can be induced by increasing a loftiness of the polishing pad on the backup pad attachment side. For example, a multilayer foam polishing pad may have a lower density foam on the backup pad attachment side, and a higher density foam on the worksurface contacting side, the lower density foam provides better airflow while the higher density foam provides abrasion to the worksurface.

Heat can also be dissipated by including a heat transferring material in the polishing pad. For example, aluminum, copper or another thermally conductive material may be included in the foam material of the polishing pad. In some embodiments, the thermally conductive material includes strands extending through the polishing pad where heat accumulates.

Method 800 provides several options for reducing accumulated heat that may be used independently of, or in conjunction with, other options disclosed herein. It is important to balance the reduction of heat without providing enough airflow or heat transfer to dry out polish during a polishing operation. Therefore, different abrading operations may call for different combinations of heat dissipation options, depending on the length of contact time between the polishing pad and the worksurface, the rotational speed of the polishing pad, and the applied force.

A polishing operation, in step 830, proceeds as the tool spins the polishing pad in contact with a worksurface. Polish may be provided, as indicated in block 832, either from the polishing pad itself, which may be impregnated with polish, or from a polishing source. Force is provided, as indicated in block 834, by a force control unit. Other parameters 838 may be controlled by a robotic controller, including a movement path along the worksurface, angle of attack along the movement path, speed of movement along the movement path as well as rotational speed of the polishing pad during polishing.

The above-presented description and figures are intended by way of example only and are not intended to limit the illustrative embodiments in any way except as set forth in the appended claims. It is noted that various technical aspects of the various elements of the various exemplary embodiments that have been described above can be combined in numerous other ways, all of which are considered to be within the scope of the disclosure.

Accordingly, although exemplary embodiments have been disclosed for illustrative purposes, those skilled in the art will appreciate that various modifications, additions, and substitutions are possible. Therefore, the disclosure is not limited to the above-described embodiments but may be modified within the scope of appended claims, along with their full scope of equivalents.

A robotic abrading system that includes a robotic tool coupled to a robotic arm. The robotic arm is configured to move the robotic tool into an abrading position with respect to a workpiece. The system also includes a backup pad coupled to the robotic tool. The system also includes a polishing pad coupled to the backup tool. The backup pad or the polishing pad include a heat accumulation reduction mechanism that passively reduces heat accumulation within the backup pad during successive polishing operations.

The system may be implemented such that the backup pad includes the heat accumulation reduction mechanism.

The system may be implemented such that the heat accumulation reduction mechanism is a thermally conductive material in contact with the polishing pad.

The system may be implemented such that the heat accumulation reduction mechanism is an airflow feature.

The system may be implemented such that the airflow feature includes an aperture.

The system may be implemented such that the airflow feature includes a channel extending through a portion of the backup pad.

The system may be implemented such that the airflow feature includes a curved portion.

The system may be implemented such that the airflow feature includes a turbine.

The system may be implemented such that the airflow feature includes a portion of the backup pad through which air can flow.

The system may be implemented such that the backup pad includes an aperture in a surface that is in contact with the polishing pad.

The system may be implemented such that the polishing pad includes the heat accumulation reduction mechanism.

The system may be implemented such that the polishing pad is asymmetric with respect to an axis extending through a diameter of the polishing pad.

The system may be implemented such that the polishing pad has a first radius of curvature with respect to a backup pad contacting side and a second radius of curvature with respect to a workpiece contacting side.

The system may be implemented such that the polishing pad includes a workpiece contacting layer, including a first material, and a backup pad contacting layer, including a second material. The second material is less dense than the first material.

The system may be implemented such that the polishing pad includes a thermally conductive material.

The system may be implemented such that the thermally conductive material includes aluminum or copper.

The system may be implemented such that the polishing pad includes a first thickness, in a center of the polishing pad, and a second thickness, at an edge of an interface with the backup pad. The first thickness is at least twice the second thickness.

The system may be implemented such that the polishing pad is less than three inches in diameter.

The system may be implemented such that the polishing pad is less than 2.5 inches in diameter.

The system may be implemented such that the backup pad is removeably coupled to the tool.

The system may be implemented such that it includes a force controller.

The system may be implemented such that it includes a controller that adjusts a movement speed, rotational tool speed, attack angle, or force during a polishing operation.

A backup pad for a robotic abrading system is presented that includes a tool interfacing portion configured to interact with a robotic tool of the robotic abrading system. The system also includes an abrasive contacting side, opposite the tool interfacing portion. The system also includes a passive heat dissipation mechanism configured to reduce heat accumulation in an abrasive article coupled to the abrasive contacting side during a robotic abrading operation.

The system may be implemented such that the passive heat dissipation mechanism is a thermally conductive material in contact with the polishing pad.

The system may be implemented such that the passive heat dissipation mechanism includes an airflow feature.

The system may be implemented such that the airflow feature includes an aperture.

The system may be implemented such that the airflow feature includes a channel extending through a portion of the backup pad.

The system may be implemented such that the passive heat dissipation mechanism includes a plurality of fins coupled to the abrasive contacting side.

The system may be implemented such that the airflow feature includes a curved portion configured to cause air to flow over the abrasive contacting side during a robotic abrading operation.

The system may be implemented such that the airflow feature includes a turbine.

The system may be implemented such that the airflow feature includes a cavity within the backup pad through which air can flow.

The system may be implemented such that the tool interface portion includes an aperture.

The system may be implemented such that the abrasive contacting side includes an aperture.

The system may be implemented such that the polishing pad is less than three inches in diameter.

The system may be implemented such that the polishing pad is less than 2.5 inches in diameter.

The system may be implemented such that the backup pad is removeably coupled to the tool.

The system may be implemented such that the backup pad includes a compliant material.

The system may be implemented such that the backup pad includes a rigid material.

The system may be implemented such that the backup pad includes a flexible material.

A polishing pad for a robotic abrading system is presented that includes a compressible material configured to contact a worksurface, on a first side, and couple to a backup pad, on a second side. The compressible material is asymmetric shape with respect to a diameter of the polishing pad.

The polishing pad may include a heat accumulation reduction mechanism.

The polishing pad may have a first radius of curvature with respect to the first side and a second radius of curvature with respect to the second side.

The polishing pad may include a workpiece contacting layer, including a first material, and a backup pad contacting layer, including a second material. The second material is less dense than the first material.

The polishing pad may include a thermally conductive material.

The polishing pad may be implemented such that the thermally conductive material includes aluminum or copper.

The polishing pad may include a first thickness, in a center of the polishing pad, and a second thickness, at an edge of an interface with the backup pad. The first thickness is at least twice the second thickness.

The polishing pad may be less than three inches in diameter.

The polishing pad may be less than 2.5 inches in diameter.

symmetric with respect to an axis perpendicular to the center of the pad

The polishing pad may be implemented such that the compressible material includes an aperture.

The polishing pad may be implemented such that the compressible material includes a cavity.

The polishing pad may be implemented such that the compressible material includes a channel extending through a portion of the polishing pad.

A method of reducing heat accumulation during an abrading operation is presented that includes contacting a worksurface with an abrasive article. The abrasive article is coupled to a backup pad. The method may also include driving rotation of the abrasive article against the worksurface. Driving rotation induces airflow through the backup pad. The backup pad is coupled to a robotic tool that automatically conducts a sequence of abrasive operations. The induced airflow dissipates heat from the abrasive article.

The method may be implemented such that the abrasive article is a polishing pad. The method may be implemented such that the backup pad includes a plurality of fins.

The method may be implemented such that the backup pad includes a plurality of channels.

The method may be implemented such that the backup pad includes an aperture on an abrasive article contacting surface.

The method may be implemented such that the backup pad includes a turbine.

The method may be implemented such that the backup pad includes an internal cavity through which the induced airflow passes.

The method may be implemented such that the backup pad couples to a robotic tool, on a first side, and to the abrasive article, on a second side.

The method may be implemented such that each of a plurality of protrusions extend from the first side to the second side.

The method may be implemented such that the protrusions have curvature.

### EXAMPLES

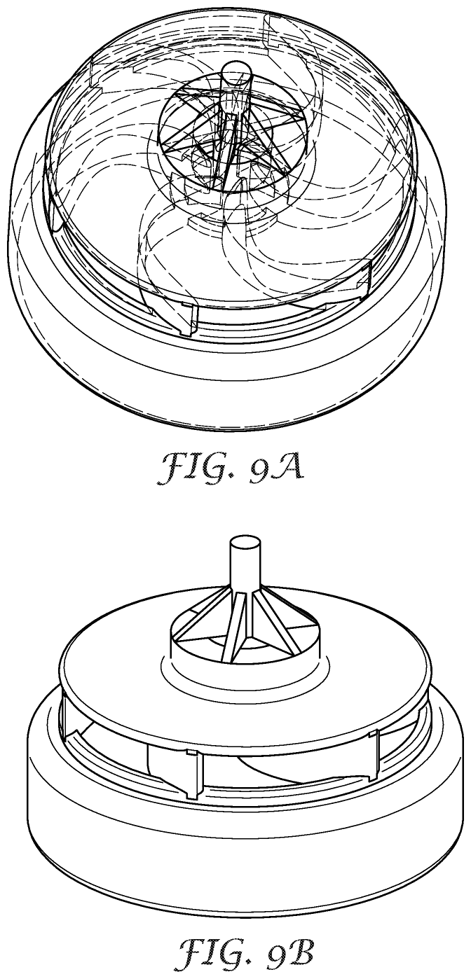

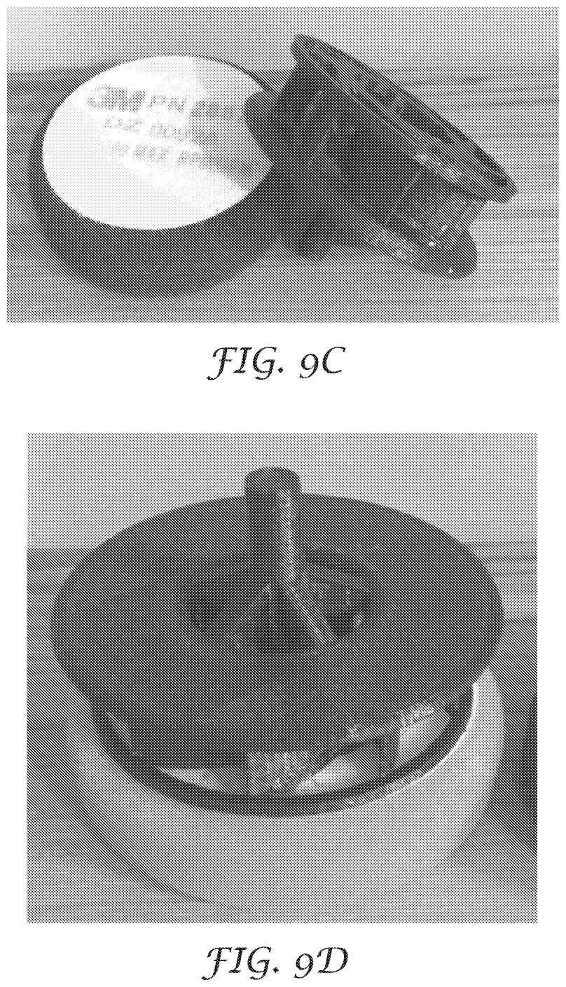

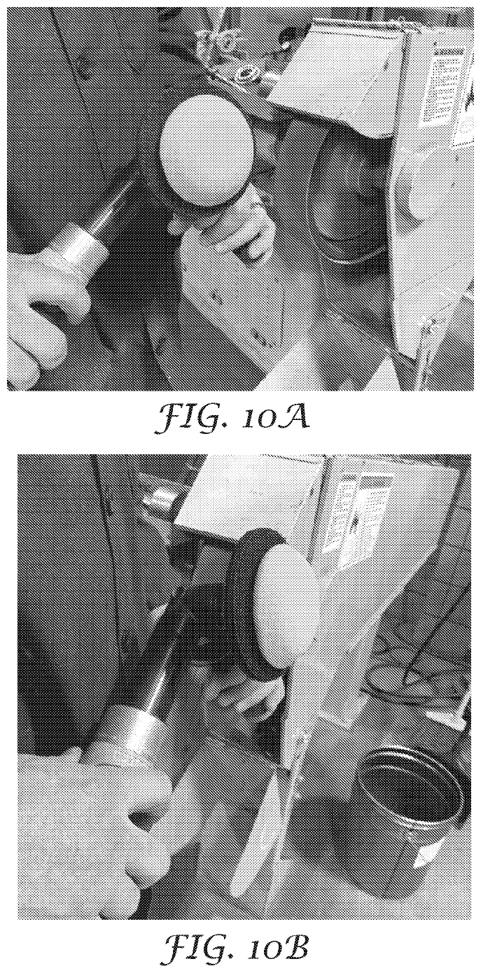

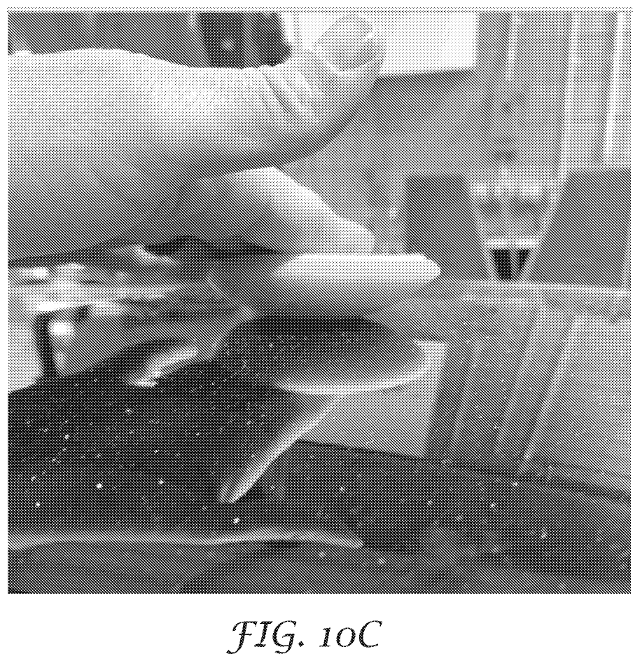

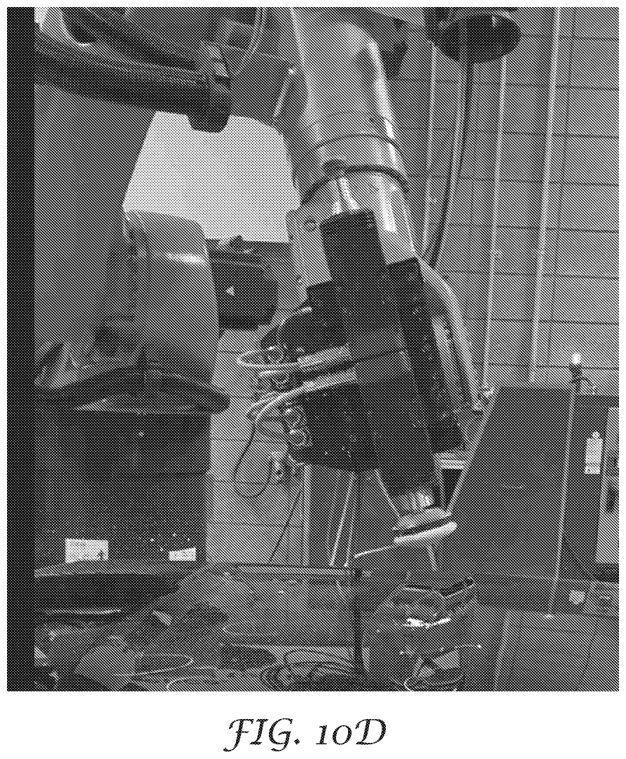

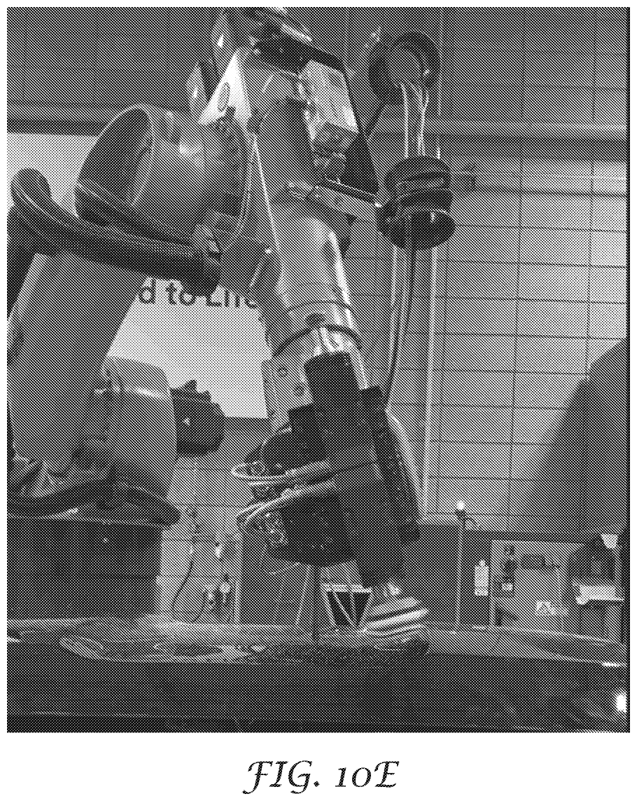

FIGS. 9-10 illustrate examples of modified backup pads and polishing pads constructed for use in robotic abrading systems.

### Example 1: Modified Backup Pad for Robotic Systems

FIGS. 9A-9B illustrate SolidWork design models of a backup pad with an internal turbine designed to provide airflow to the surface of a traditional polishing pad. The backup pad was attached to the polishing pad using Command™ Adhesive Strips from 3M, which were cut to allow for airflow. The Command™ strip hook and loop system worked well to bond the test tool to the polishing pad, as seen in FIGS. 9C-9D, which illustrate the 3D printed backup pad.

The backup pad in FIGS. 9A-9D includes apertures on both the tool-engaging side and the polishing pad-engaging side that allow air to freely flow through the backup pad during rotation.

### Example 2: Modified Polishing Pad for Robotic Systems

FIGS. 10A-10B illustrate the process of making a modified polishing pad as illustrated in FIGS. 10C-10E. The polishing pads illustrated in FIGS. 6B-6C were made in a similar manner. A traditional polishing pad was ground down using an abrasive belt to increase the curvature on the worksurface-contacting side. A diameter of the worksurface contact side is smaller than the backup pad contacting side, reducing the overall volume of polishing pad material that can accumulate heat.

FIG. 10C illustrates a side view of the modified polishing pad. As illustrated, there is about a 4× reduction in height of the pad from the center to the edge of the backup pad contact interface.

FIGS. 10D-10E illustrate the modified polishing pad mounted to a robotic arm. The modified polishing pad design provides increased flexibility for addressing curvature of a worksurface as attack angles can change without needing to provide significantly more force.

What is claimed is:

1. A backup pad for a robotic abrading system, the backup pad comprising:
a tool interfacing portion configured to interact with a robotic tool of the robotic abrading system;
an abrasive contacting side, opposite the tool interfacing portion; and
a passive heat dissipation mechanism configured to reduce heat accumulation in an abrasive article coupled to the abrasive contacting side during a robotic abrading operation.

2. The system of claim 1, wherein the passive heat dissipation mechanism is a thermally conductive material in contact with the polishing pad.

3. The system of claim 1, wherein the passive heat dissipation mechanism comprises an airflow feature.

4. The system of claim 3, wherein the airflow feature comprises an aperture.

5. The system of claim 3, wherein the airflow feature comprises a channel extending through a portion of the backup pad.

6. The system of claim 3, wherein the passive heat dissipation mechanism comprises a plurality of fins coupled to the abrasive contacting side.

7. The system of claim 3, wherein the airflow feature comprises a curved portion configured to cause air to flow over the abrasive contacting side during a robotic abrading operation.

8. The system of claim 7, wherein the airflow feature comprises a turbine.

9. The system of claim 7, wherein the airflow feature comprises a cavity within the backup pad through which air can flow.

10. The system of claim 1, wherein the tool interface portion comprises an aperture.

11. The system of claim 1, wherein the abrasive contacting side comprises an aperture.

12. The system of claim 1, wherein the polishing pad is less than three inches in diameter.

13. The system of claim 12, wherein the polishing pad is less than 2.5 inches in diameter.

14. The system of claim 1, wherein the backup pad is removably coupled to the tool.

15. The system of claim 1, wherein the backup pad comprises a compliant material.

16. The system of claim 1, wherein the backup pad comprises a rigid material.

17. The system of claim 1, wherein the backup pad comprises a flexible material.

18. A polishing pad for a robotic abrading system, the polishing pad comprising:
a compressible material configured to contact a worksurface, on a first side, and couple to a backup pad, on a second side; and
wherein the compressible material is asymmetric shape with respect to a diameter of the polishing pad.

19-29. (canceled)

30. A method of reducing heat accumulation during an abrading operation, the method comprising:
contacting a worksurface with an abrasive article, wherein the abrasive article is coupled to a backup pad;
driving rotation of the abrasive article against the worksurface, wherein driving rotation induces airflow through the backup pad; and
wherein the backup pad is coupled to a robotic tool that automatically conducts a sequence of abrasive operations and wherein the induced airflow dissipates heat from the abrasive article.

31-39. (canceled)
